(19) United States
(12) Patent Application Publication
(10) Pub. No.: US 2012/0031371 A1
(43) Pub. Date: Feb. 9, 2012

(54) METHOD FOR OPERATING AN INTERNAL COMBUSTION ENGINE HAVING SPARK IGNITION

(75) Inventor: Daniel Sabathil, Seeheim-Jugenheim (DE)

(73) Assignee: GM GLOBAL TECHNOLOGY OPERATIONS LLC, Detroit, MI (US)

(21) Appl. No.: 13/196,548

(22) Filed: Aug. 2, 2011

(30) Foreign Application Priority Data
Aug. 4, 2010 (DE) 102010033394.8

(51) Int. Cl. F02D 41/30; F02M 21/02

(52) U.S. Cl. 123/294

(57) ABSTRACT

A method is provided for operating an internal combustion engine having a spark ignition unit. A liquid fuel is mixed with air in an injection procedure and, after ignition by the spark ignition unit, combusted while discharging mechanical power. A liquefied gas is combusted as the liquid fuel. The liquefied gas is at least partially injected using a direct injection nozzle into the combustion cylinder before the ignition by the spark ignition unit. A cooling unit cools the liquefied gas at least in a return line or a supply line.

### CROSS-REFERENCE TO RELATED APPLICATION

This application claims priority to German Patent Application No. 102010033394.8, filed Aug. 4, 2010, which is incorporated herein by reference in its entirety.

### TECHNICAL FIELD

The technical field relates to a method for operating an internal combustion engine having a spark ignition unit. A liquid fuel is mixed with air in an injection procedure and, after ignition by an ignition spark of the spark ignition unit, combusted while discharging mechanical power. A liquefied gas is combusted as the liquid fuel.

### BACKGROUND

A method is known from the publication U.S. Pat. No. 4,430,978, in which a fuel injection device and an injection system inject liquefied gas (LPG, liquefied petroleum gas) into at least one chamber, which mixes fuel and air, from a storage means, which keeps the pressurized liquefied gas in its liquid state. The fuel injection device is adapted to receive the pressurized liquefied gas from the storage means and deliver it in its liquid state into the air/fuel mixing chamber.

In the case of such an injection method, which only injects the liquefied gas into an intake duct or into an air/fuel mixing chamber, the resulting air/combustion gas mixture is typically supplied to a combustion chamber in homogenized form, so that an extremely fuel-lean phase or a charge stratification cannot form between the liquid gas layer and the air layer of a combustion chamber in the cylinder head. Therefore, extremely lean stages of the air-liquid gas mixture cannot be implemented using the known method

Therefore, at least one object is to specify a method in which not only can a homogenized and/or stoichiometric air-liquid gas mixture be supplied to the combustion chamber in the cylinder head before an ignition procedure, but rather also the particularly efficient charge stratification of air layers and liquid gas layers can be used. In addition, other objects, desirable features and characteristics will become apparent from the subsequent summary and detailed description, and the appended claims, taken in conjunction with the accompanying drawings and this background.

### SUMMARY

A method is provided for operating an internal combustion engine having a spark ignition unit is proposed. A liquid fuel is mixed with air in an injection procedure and, after ignition by the spark ignition unit, combusted while discharging mechanical power. A liquefied gas is combusted in a gaseous aggregate state as the liquid fuel. The liquefied gas is at least partially injected into the combustion cylinder using a direct injection nozzle before the ignition by the spark ignition unit. A cooling unit cools the liquefied gas at least in one line.

This method has the advantage that not only can a homogenized air-liquid gas mixture in the combustion cylinder be supplied in compressed form to a combustion chamber by the cylinder piston, but rather it is also possible to achieve a charge stratification through the direct injection. The engine can thus be operated having oxygen excess at an optimum thermodynamic operating point, which increases the efficiency in part-load operation in particular. Lower consumption and lower carbon dioxide emissions simultaneously result therefrom. Significant consumption savings can be achieved using this possibility of so-called lean operation. In addition, cooling of the liquefied gas is achieved, so that the liquid gas fuel flows in a noncritical liquefied phase in a supply line under high pressure and/or in a return line, whereby the safety of the method is increased.

For this purpose, in one performance form of the method, the following method steps are performed. Firstly, supply lines are provided for the liquefied gas to the direct injection nozzle, which protrudes into a combustion chamber of a cylinder head. Then, with the aid of the direct injection nozzle, direct injection of a liquefied gas quantity under high pressure into the combustion chamber of the cylinder head can be performed during an intake phase of a reciprocating piston or a compression phase. In the compression phase, a cylinder volume which is charged with air or with a liquid gas-air mixture is compressed in the combustion cylinder using the reciprocating piston in the direction of the combustion chamber in the cylinder head. Close to an apex of the reciprocating piston, the ignition of the liquid gas-air mixture, this is under high pressure, by means of an ignition spark in the combustion chamber follows. The at least partially injected liquefied gas quantity is then combusted while discharging mechanical power via a connecting rod to a crankshaft.

To perform these method steps, the liquefied gas is supplied from a pressurized liquid gas container to the direct injection nozzle using a high-pressure pump via the supply lines. The fuel mass proportion which is combusted, in the form of the so-called MFB value (mass fraction burned), during the combustion is greater than approximately 50% on a scale from approximately 0% to approximately 100% using the method of direct injection of the liquefied gas into the combustion cylinder or into the combustion chamber of the combustion cylinder, whereby more fuel mass is converted into mechanical power.

Moreover, through the cooling effect of the atomized and vaporized liquefied gas directly into the combustion chamber, premature ignition of the liquid gas-air mixture in the combustion chamber can be prevented, so that knocking due to the direct injection is prevented in relation to a typical injection method into an intake duct of the internal combustion engine or into a mixing chamber of the internal combustion engine, as is known from the above publication.

In addition, this method has the advantage that it uses the reduced flashpoint of the liquefied gas in relation to typical liquid fuels for the purpose of thermally stressing the cylinder head less. In addition, through the reduced flashpoint in relation to typical liquid fuels such as gasoline, the nitrogen oxide emission is reduced in spite of charge stratification, which is to be attributed to the reduced flashpoint of the liquefied gas, since the nitrogen oxide formation is not solely dependent on the oxygen excess, but rather also on the combustion temperature, the nitrogen oxide formation also decreasing with reduced combustion temperature.

In addition, it is possible through the cooling effect in the case of direct injection of the liquefied gas in the combustion cylinder during the compression phase of the second stroke of a four-stroke internal combustion engine to achieve an increased oxygen uptake in the combustion cylinder and thus allow the above-mentioned increase of the MFB value (mass fraction burned) while simultaneously reducing nitrogen oxides because of the reduced temperature of the flashpoint of liquefied gas.

Through the cooling effect of the liquefied gas, an increased oxygen uptake can be caused in the combustion cylinder in the case of direct injection in the compression phase and a charge stratification can be achieved. A fuel-lean combustion phase is thus made possible as the third stroke of a four-stroke internal combustion engine, particularly because homogenized liquid gas-air mixture is not present at the moment of ignition due to the charge stratification.

In addition, a further variation of the direct injection allows multiple direct injections of liquid gas, after ignition of an initially lean fuel-air mixture having charge stratification has already occurred in the combustion chamber. This means that in this method, firstly an ultra-lean liquid gas-air mixture is ignited with the aid of the spark ignition unit, and subsequently during the power stroke or the third stroke of a four-stroke internal combustion engine, the mixture is enriched with liquefied gas by dosing using multiple direct injections. The consumption of liquefied gas can thus be minimized and a higher power output to the crankshaft via the connecting rod can be achieved simultaneously.

An internal combustion engine having direct injection unit of a liquefied gas has a direct injection unit having a direct injection nozzle in a cylinder head. The direct injection nozzle is connected via an injection valve to a fuel supply line. A return line, which is connected to the injection valve for returning excess fuel, or the supply line for the fuel has a cooling unit. This internal combustion engine has the advantage due to the cooling unit in at least one of the fuel lines that the liquefied gas can be supplied in a noncritical liquid state via a high-pressure pump to the fuel supply line, whereby the safety of the internal combustion engine having direct injection unit for liquefied gas is improved.

A computer program is also provided which, when it runs in an engine controller, causes the engine controller to perform one of the described methods.

### BRIEF DESCRIPTION OF THE DRAWINGS

The present invention will hereinafter be described in conjunction with the following drawing figures, wherein like numerals denote like elements, and:

FIG. 1 shows a perspective view in partial section of a cylinder head of a four-stroke internal combustion engine according to a first embodiment; and

FIG. 2 shows a perspective view in partial section of a cylinder head of a four-stroke internal combustion engine according to a second embodiment.

### DETAILED DESCRIPTION

The following detailed description is merely exemplary in nature and is not intended to limit application and uses. Furthermore, there is no intention to be bound by any theory presented in the preceding or summary or the following detailed description.

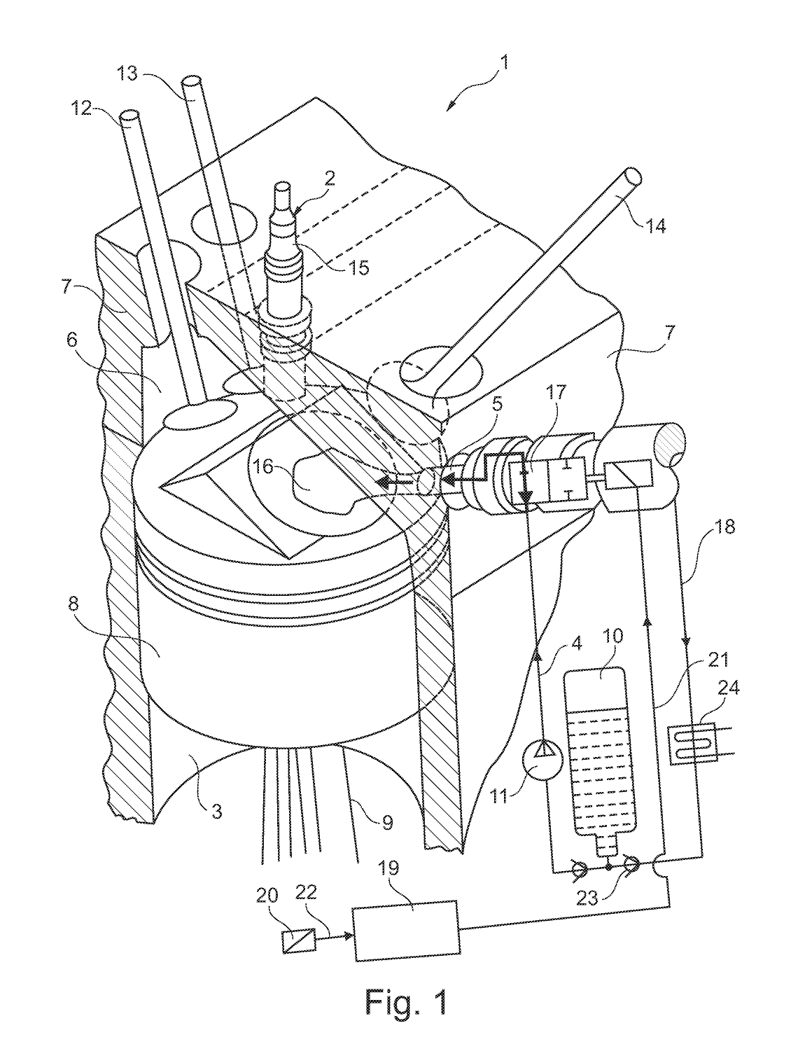

FIG. 1 shows a perspective view in partial section of a cylinder head 7 of a four-stroke internal combustion engine 1 according to a first embodiment. The cylinder head 7 of an internal combustion engine 1 has, in addition to two inlet valves 12 and 13, an outlet valve 14. In addition, a spark plug 15 of a spark ignition unit 2 is shown in FIG. 1. A reciprocating piston 8, which cooperates with a connecting rod 9, is located in a compression phase of the four-stroke internal combustion engine 1, in which, for example, air charged by a turbocharger is compressed, while liquefied gas 16 is injected via a direct injection nozzle 5 directly into the combustion chamber 6. This liquefied gas is supplied to a direct injection nozzle 5 from a liquid gas container 10 via a high-pressure pump 11 and a high-pressure line 4, an electronically controlled direct injection valve 17, which is controlled by a control and regulating unit 19 via a control line 21, regulates an injection quantity of the liquefied gas and an injection time span as a function of sensors 20, which cooperate with a gas pedal of the vehicle and a crankshaft of the internal combustion engine, for example, and are connected via signal lines 22 to the control and regulating unit 19.

Using such direct injection, as shown in FIG. 1, multiple injections of the liquefied gas during the combustion procedure can be provided during the power stroke. For example, at the apex of the reciprocating piston, a lean stage can be ignited with the aid of the ignition device 2 and further liquefied gas can be injected by further injection procedures as the reciprocating piston 8 is pressed down into the combustion cylinder 3, until finally a stoichiometric air-liquid gas mixture stage or even an enriched air-liquid gas mixture stage is achieved upon conclusion of the power stroke. In addition, a return line 18 from the direct injection nozzle 5 to the liquid gas container 10 via a check valve 23 is provided for excess supplied liquefied gas. In FIG. 1, a cooling unit 24 is provided in the return line 18 for excess fuel, which cools the fuel in such a way that it can be supplied in a noncritical liquid aggregate state via the check valve 23 of the high-pressure pump 11.

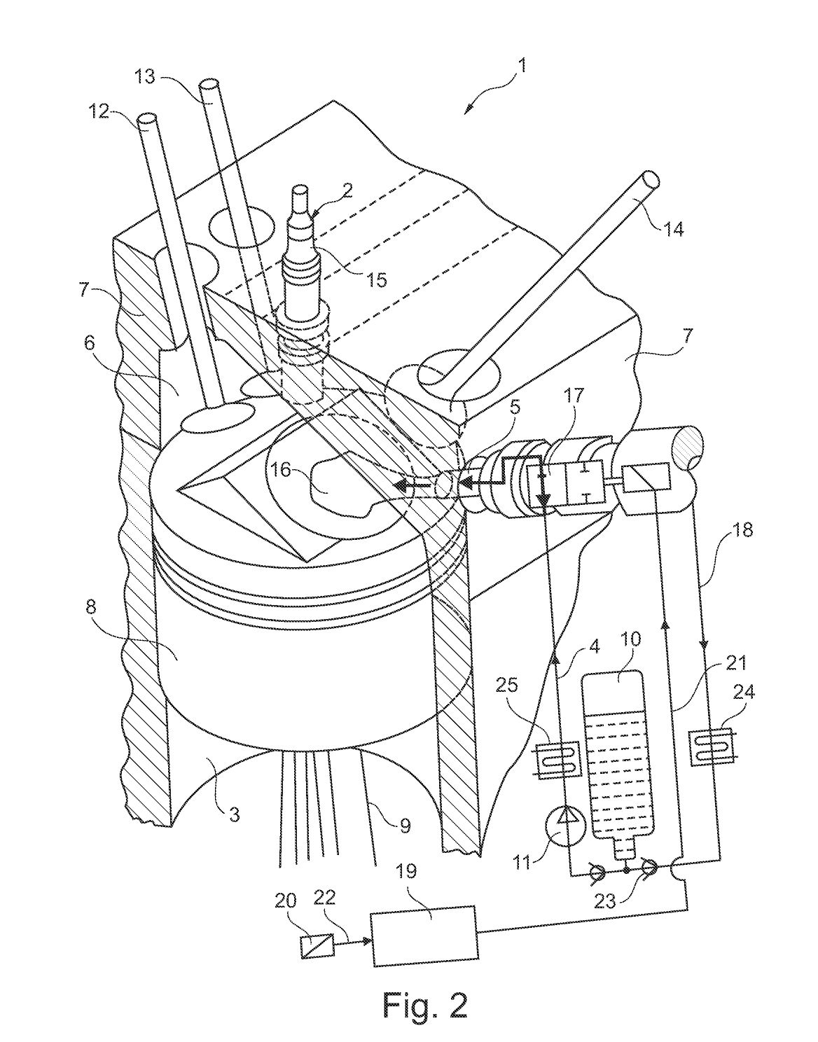

FIG. 2 shows a perspective view in partial section of a cylinder head 7 of a four-stroke internal combustion engine 1 according to a second embodiment. Components having identical functions as in FIG. 1 are identified by identical reference numerals and are not explained further.

The embodiment of FIG. 2 differs from the embodiment according to FIG. 1 in that, additionally or alternatively to the cooling unit 24 in the return line, a cooling unit 25 is provided in the high-pressure line 4 downstream from the high-pressure pump 11, in order to ensure that after the heating by the compression process in the high-pressure pump 11, the liquefied gas is supplied in a noncritical liquefied aggregate state to the direct injection valve 17.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A method for operating an internal combustion engine having a spark ignition unit, comprising:
mixing a liquid fuel with air using injection in a combustion cylinder and combusting the liquid fuel that is mixed with the air while discharging mechanical power after an ignition by the spark ignition unit;
combusting a liquefied gas as the liquid fuel;
at least partially injecting the liquefied gas using a direct injection nozzle into the combustion cylinder before the ignition by the spark ignition unit; and
cooling the liquefied gas in a line with a cooling unit.

2. The method according to claim 1, wherein the line is a return line.

3. The method according to claim 1, wherein the line is a supply line.

4. The method according to claim 3,
wherein the supply line for the liquefied gas to the direct injection nozzle that protrudes into a combustion chamber of a cylinder head, and
wherein the method further comprises:
direct injecting of a liquefied gas quantity under high pressure into the combustion cylinder during an intake phase in the combustion chamber of the cylinder head;
compressing a cylinder volume that is charged with a liquid gas-air mixture in the combustion cylinder using a reciprocating piston in a direction toward the combustion chamber of the cylinder head;
igniting the liquid gas-air mixture that is under high pressure using an ignition spark in the combustion chamber close to an apex of the reciprocating piston; and
combusting an at least partially injected liquefied gas quantity while discharging mechanical power to a crankshaft via a connecting rod; and
cooling the liquefied gas in the supply line that is under high pressure.

5. The method according to claim 3, further comprising supplying the liquefied gas from a pressurized liquid gas container using a high-pressure pump via the supply line to the direct injection nozzle.

6. The method according to claim 1, further comprising combusting a fuel mass proportion of greater than approximately 50% in a scale of approximately 0% to approximately 100% during the combusting and converting into mechanical power using a direct injection of the liquefied gas.

7. The method according to claim 1, further comprising cooling the liquefied gas by atomizing and vaporizing.

8. The method according to claim 4, further comprising reducing a flashpoint of the liquefied gas by a direct injection of the liquefied gas into the combustion chamber of the cylinder head after a compression phase.

9. The method according to claim 8, further comprising increasing an oxygen uptake in the combustion cylinder caused by a cooling effect during the direct injection of the liquefied gas into the combustion cylinder during the compression phase of a second stroke of a four-stroke internal combustion engine.

10. The method according to claim 8, further comprising performing multiple direct injections of the liquefied gas successively in a power phase during a third stroke of a four-stroke internal combustion engine after the ignition of a lean liquid gas-air mixture having charge stratification in the combustion chamber.

11. The method according to claim 3, further comprising cooling the supply line with the cooling unit after heating by a compression process in a high-pressure pump so the liquefied gas is supplied in a noncritical liquefied aggregate state to the direct injection nozzle.

12. The method according to claim 2, further comprising:
cooling excess fuel in the return line with the cooling unit; and
cooling in a supply line with the cooling unit.

13. An internal combustion engine, comprising:
a direct injection unit of a liquefied gas having a direct injection nozzle in a cylinder head,
an injection valve configured to connect the direct injection unit to a fuel supply line; and
a cooling unit connected to a return line that is connected to the injection valve to cool the liquefied gas in a noncritical liquid state.

14. The internal combustion engine according to claim 13, further comprising a liquid gas container that is configured for pressurization and configured to contain the liquefied gas that is connected via a supply line to the direct injection nozzle.

15. The internal combustion engine according to claim 14, further comprising a high-pressure pump configured to compress the liquefied gas before the supplying in the supply line.

16. A computer readable medium embodying a computer program product, said computer program product comprising:
a program for operating an internal combustion engine having a spark ignition unit the program configured to:
mix a liquid fuel with air using injection in a combustion cylinder;
combust the liquid fuel that is mixed with the air while discharging mechanical power after an ignition by the spark ignition unit;
combust a liquefied gas as the liquid fuel; and
at least partially inject the liquefied gas using a direct injection nozzle into the combustion cylinder before the ignition by the spark ignition unit; and
cool the liquefied gas in a line with a cooling unit.

17. The computer readable medium embodying the computer program product according to claim 16, wherein the line is a return line.

18. The computer readable medium embodying the computer program product according to claim 16, wherein the line is a supply line.

19. The computer readable medium embodying the computer program product according to claim 18,
wherein the supply line for the liquefied gas to the direct injection nozzle that protrudes into a combustion chamber of a cylinder head, and
wherein the program is further configured to:
direct inject a liquefied gas quantity under high pressure into the combustion cylinder during an intake phase of a reciprocating piston or a compression phase in the combustion chamber of the cylinder head;
compress a cylinder volume that is charged with a liquid gas-air mixture in the combustion cylinder using the reciprocating piston in a direction toward the combustion chamber of the cylinder head;
ignite the liquid gas-air mixture that is under high pressure using an ignition spark in the combustion chamber close to an apex of the reciprocating piston; and
combust an at least partially injected liquefied gas quantity while discharging mechanical power to a crankshaft via a connecting rod; and
cool the liquefied gas in the supply line that is under high pressure.

20. The computer readable medium embodying the computer program product according to claim 18, the program further configured to supply the liquefied gas from a pressurized liquid gas container using a high-pressure pump via the supply line to the direct injection nozzle.
